(19) United States
(12) Patent Application Publication
(10) Pub. No.: US 2005/0266736 A1
(43) Pub. Date: Dec. 1, 2005

(54) Fixing rail of terminal block for electric/electronic components

(75) Inventors: Young Sun Won, Pusan (KR); Sang Joon Won, Pusan (KR)

Correspondence Address: NOTARO AND MICHALOS, 100 DUTCH HILL ROAD, SUITE 110, ORANGEBURG, NY, 10962-2100, US

(73) Assignee: LATCH WON CO,. LTD, Pusan 617-050 (KR)

(21) Appl. No.: 10/521,869

(22) PCT Filed: Sep. 7, 2002
(86) PCT No.: PCT/KR02/01693

§ 371 Date: Jan. 21, 2005

(30) Foreign Application Priority Data
Jul. 24, 2002 (KR) 2002/22117 U

(51) Int. Cl. H01R 9/26

(52) U.S. Cl. 439/716

(57) ABSTRACT

Disclosed is a fixing rail of a terminal block capable of easily assembling various electric/electronic components. Electric/electronic devices and so forth in a control box, and facilitating the maintenance thereof, as well as the easy movement thereof. The fixing rail of a terminal block includes wings (12) extended from both sides of a C-shaped body (10), with a plurality of bodies arranged in a row, the respective bodies (10) provided at a center thereof with a hole (14), and a plurality of holes (14) formed at the bodies being spaced apart from each other at regular intervals. The fixing rail comprises a cutting groove (2) formed between the bodies, the cutting groove (2) provided at upper and lower portions of the body (10); and a gap (1) formed between ends of the wings (12), such that the fixing rail may be cut by a desired length using a hand or nipper, without using a cutter or a saw.

### TECHNICAL FIELD

The present invention relates to a fixing rail of a terminal block for electric/electronic components, and more particularly to a fixing rail of a terminal block capable of easily assembling various electric/electronic components, electric/electronic devices and so forth in a control box, and facilitating the maintenance thereof, as well as the easy movement-thereof.

### BACKGROUND ART

Generally, a fixing rail of a terminal block is used to easily assemble various electric/electronic components, electric/electronic devices and so forth in a control box, and facilitate the maintenance thereof, as well as the easy movement thereof. The fixing rail is generally made of aluminum, and has wings 12 extended from both sides of a [symbol] -shaped body 10. The body 10 is provided at a center thereof with a plurality of holes 14 spaced apart from each other at regular intervals for fixing the fixing rail itself or other components. The holes are primarily formed by an extrusion, and are secondarily formed by machining operation.

The fixing rail of the terminal block is made to have a length of about 1 meter, and then is distributed to users. The user cuts the fixing rail by a required length, if necessary. Since the fixing rail has a thickness of about 1 mm, it is difficult to cut it using a hand or a nipper. Therefore, the fixing rail is cut using a cutter or a saw, and so the working time is extended and the workability is poor. In addition, the user always has to carry the cutter or saw, thereby causing the cumbersome. Furthermore, the cut portion of the fixing rail is sharp, thereby injuring the hand of user.

### DISCLOSURE OF THE INVENTION

Therefore, an object of the present invention is to solve the problems involved in the prior art, and to provide a fixing rail of a terminal block for electric/electronic components capable of be cutting by a desired length using a hand or a nipper, without using a cutter or saw.

In order to accomplished the above mentioned objects, the present invention provides a fixing rail of a terminal block including wings extended from both sides of a [symbol] -shaped body, with a plurality of bodies arranged in a row, the respective bodies provided at a center thereof with a hole, and a plurality of holes formed at the bodies being spaced apart from each other at regular intervals, the fixing rail comprising: a cutting groove formed between the bodies, the cutting groove provided at upper and lower portions of the body; and a gap formed between ends of the wings, such that the fixing rail may be cut by a desired length using a hand or nipper, without using a cutter or a saw.

According to another aspect of the present invention, there is provided a fixing rail of a terminal block including wings extended from both sides of a [symbol] -shaped body, with a plurality of bodies arranged in a row, the respective bodies provided at a center thereof with a hole, and a plurality of holes formed at the bodies being spaced apart from each other at regular intervals, the fixing rail comprising: a cutting groove formed between the bodies, the cutting groove provided at upper and lower portions of the body; a hole formed between the adjacent wings of the bodies to provide a portion of the wing with a connecting strip, such that the fixing rail may be cut by a desired length using a hand or nipper, without using a cutter or a saw.

According to further another aspect of the present invention, there is provided with a fixing rail of a terminal block including wings extended from both sides of a [symbol] -shaped body, with a plurality of bodies arranged in a row, the respective bodies provided at a center thereof with a hole, and a plurality of holes formed at the bodies being spaced apart from each other at regular intervals, the fixing rail comprising: a cutting groove formed between the bodies, the cutting groove provided at any of upper and lower portions of the body; and a gap formed between ends of the wings, such that the fixing rail may be cut by a desired length using a hand or nipper, without using a cutter or a saw.

According to still another aspect of the present invention, there is provide with a fixing rail of a terminal block including wings extended from both sides of a [symbol] -shaped body, with a plurality of bodies arranged in a row, the respective bodies provided at a center thereof with a hole, and a plurality of holes formed at the bodies being spaced apart from each other at regular intervals, the fixing rail comprising: a cutting groove formed between the bodies, the cutting groove provided at any of upper and lower portions of the body; a hole formed between the adjacent wings of the bodies to provide a portion of the wing with a connecting strip, such that the fixing rail may be cut by a desired length using a hand or nipper, without using a cutter or a saw.

### BRIEF DESCRIPTION OF THE DRAWINGS

The above objects, other features and advantages of the present invention will become more apparent by describing the preferred embodiment thereof with reference to the accompanying drawings, in which:

FIG. 1 is a perspective view of a fixing rail according to one preferred embodiment of the present invention.

FIG. 2 is a plan view of the fixing rail shown in FIG. 1.

FIG. 3 is a perspective view of a fixing rail according to another preferred embodiment of the present invention.

FIG. 4 is a plan view of the fixing rail shown in FIG. 2.

FIG. 5 is a cross sectional view taken along a line A-A in FIG. 2.

FIG. 6 is a cross sectional view taken along a line B-B in FIG. 4.

### BEST MODE FOR CARRYING OUT THE INVENTION

Reference will now be made in detail to preferred embodiments of the present invention, examples of which are illustrated in the accompanying drawings.

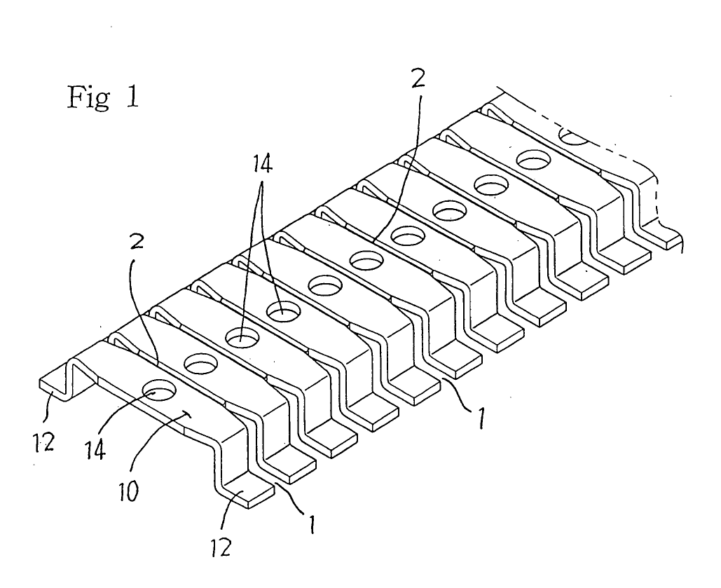

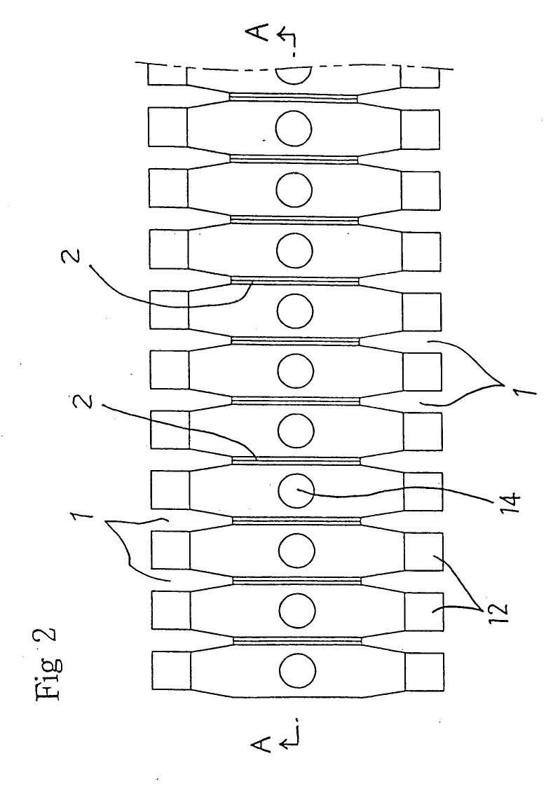

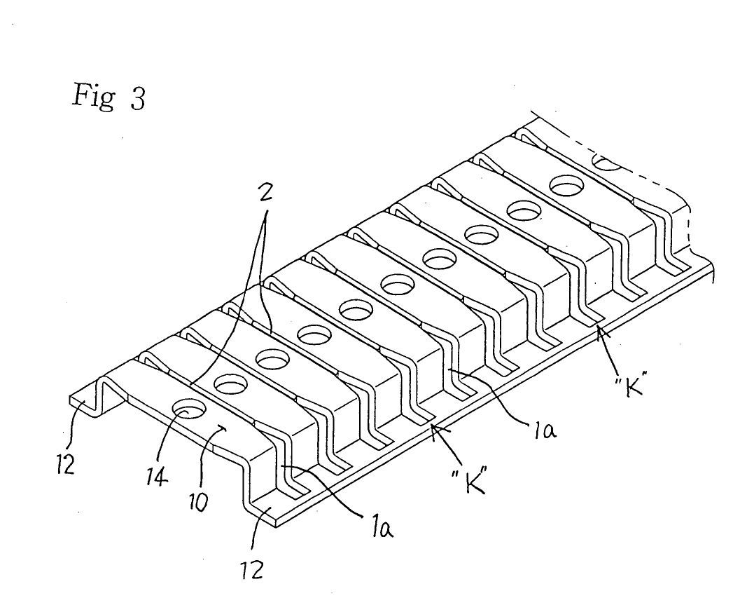

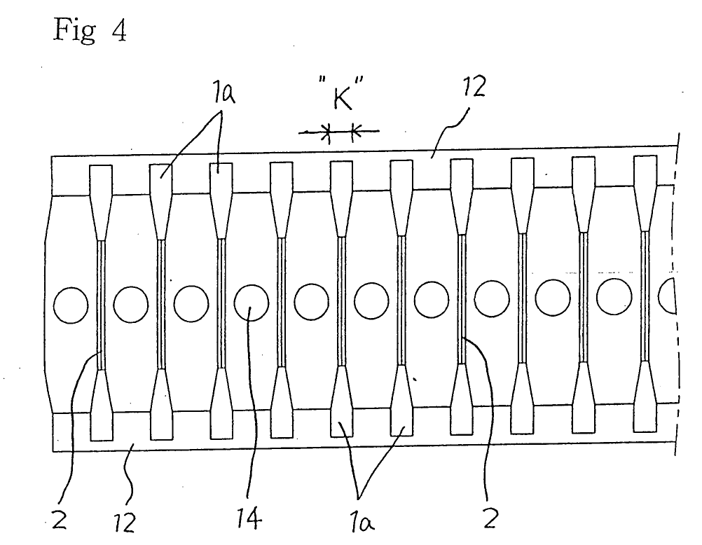

FIG. 1 is a perspective view of a fixing rail according to one preferred embodiment of the present invention, and FIG. 3 is a perspective view of a fixing rail according to another preferred embodiment of the present invention.

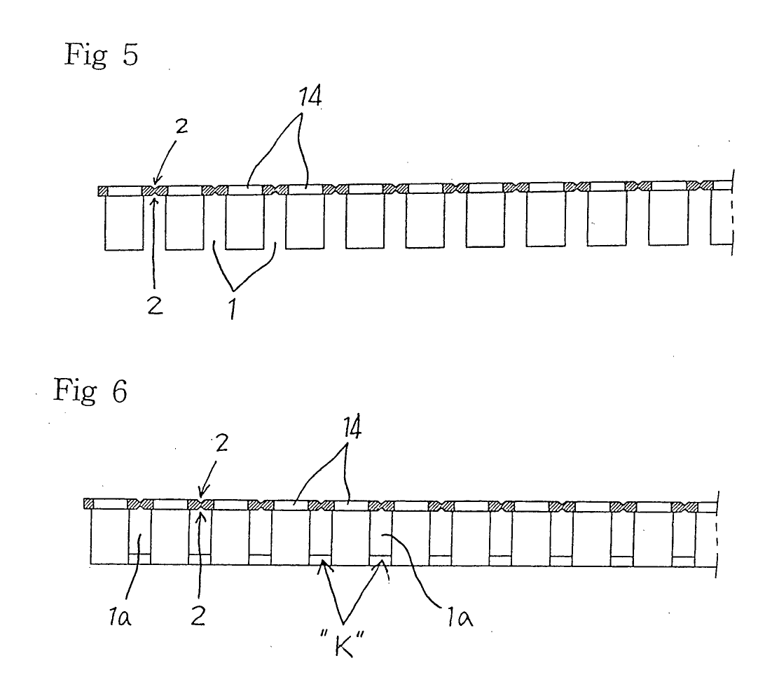

As shown in FIG. 1, a fixing rail of a terminal block includes wings 12 extended from both sides of a [symbol] -shaped body 10, with a plurality of bodies arranged in a row. The body 10 is provided at a center thereof with a hole 14, and a plurality of holes 14 formed at the bodies are spaced apart from each other at regular intervals. A cutting groove 2 is formed between the bodies, and a gap 1 is formed between ends of the wings 12. The cutting groove 2 is provided at upper and lower portions of the body 10, as shown in FIG. 5, but it may formed at either of the upper and lower portions, if necessary.

As shown in FIG. 3, the embodiment is similar to the above embodiment shown in FIG. 1, except that a hole 1a is formed between the adjacent wings of the bodies to provide the wing with a connecting strip K.

When the fixing rail is used, the fixing rail according to the embodiment shown in FIG. 1 is bent at a desired portion by a hand, so that the cutting groove corresponding to the desired portion is cut. If the hand is not well, the fixing rail may be cut by bending and spreading two or three times using a nipper, with the nipper gripping around a periphery of the cutting groove.

In case of the fixing rail shown in FIG. 3, since the hole 1a is formed between the adjacent wings of the bodies to provide the wing with a connecting strip K, it is difficult to cut it by the hand. Therefore, after the connecting strip K is first cut by the nipper, the body may be cut by the hand or nipper. Since the embodiment has strength stronger than the above embodiment, there is an advantage of reducing the deformation thereof when transporting or depositing.

Meanwhile, according to the embodiments of the present invention, it is noted that the cutting groove may be formed at the upper or lower portion of the body 10.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

As apparent from the above description, the fixing rail may be cut by a desired length using the hand or nipper, without using a cutter or saw. It is economical because of purchasing the cutter or saw. In addition, since it is unnecessary to carry the cutter or saw, the operation is easily performed. The time required for cutting the fixing rail is reduced by above 95%, thereby improving the working efficiency. Furthermore, the cut surface of the body is smooth, thereby providing a good appearance and preventing the user from being injured.

1. A fixing rail of a terminal block including wings 12 extended from both sides of a [symbol] -shaped body 10, with a plurality of bodies arranged in a row, the respective bodies 10 provided at a center thereof with a hole 14, and a plurality of holes 14 formed at the bodies being spaced apart from each other at regular intervals, the fixing rail comprising:
a cutting groove 2 formed between the bodies, the cutting groove 2 provided at upper and lower portions of the body 10; and
a gap 1 formed between ends of the wings 12,
such that the fixing rail may be cut by a desired length using a hand or nipper, without using a cutter or a saw.

2. A fixing rail of a terminal block including wings 12 extended from both sides of a [symbol] -shaped body 10, with a plurality of bodies arranged in a row, the respective bodies 10 provided at a center thereof with a hole 14, and a plurality of holes 14 formed at the bodies being spaced apart from each other at regular intervals, the fixing rail comprising:
a cutting groove 2 formed between the bodies, the cutting groove 2 provided at upper and lower portions of the body 1;
a hole 1a formed between the adjacent wings 12 of the bodies to provide a portion of the wing with a connecting strip K,
such that the fixing rail may be cut by a desired length using a hand or nipper, without using a cutter or a saw.

3. A fixing rail of a terminal block including wings 12 extended from both sides of a [symbol] -shaped body 10, with a plurality of bodies arranged in a row, the respective bodies 10 provided at a center thereof with a hole 14, and a plurality of holes 14 formed at the bodies being spaced apart from each other at regular intervals, the fixing rail comprising:
a cutting groove 2 formed between the bodies, the cutting groove 2 provided at any of upper and lower portions of the body 10; and
a gap 1 formed between ends of the wings 12,
such that the fixing rail may be cut by a desired length using a hand or nipper, without using a cutter or a saw.

4. A fixing rail of a terminal block including wings 12 extended from both sides of a [symbol] -shaped body 10, with a plurality of bodies arranged in a row, the respective bodies 10 provided at a center thereof with a hole 14, and a plurality of holes 14 formed at the bodies being spaced apart from each other at regular intervals, the fixing rail comprising:
a cutting groove 2 formed between the bodies, the cutting groove 2 provided at any of upper and lower portions of the body 1;
a hole 1a formed between the adjacent wings 12 of the bodies to provide a portion of the wing with a connecting strip K,
such that the fixing rail may be cut by a desired length using a hand or nipper, without using a cutter or a saw.
